(19) United States
(12) Patent Application Publication
(10) Pub. No.: US 2013/0175943 A1
(43) Pub. Date: Jul. 11, 2013

(54) Intelligent Lighting System for Sporting Apparatus

(71) Applicant: D3, LLC, Madison, AL (US)

(72) Inventor: Nason Wayne Tackett, Madison, AL (US)

(73) Assignee: D3, LLC, Madison, AL (US)

(21) Appl. No.: 13/735,389

(22) Filed: Jan. 7, 2013

Related U.S. Application Data
(60) Provisional application No. 61/583,631, filed on Jan. 6, 2012.

(51) Int. Cl. H05B 37/02

(52) U.S. Cl. CPC H05B 37/02
USPC 315/250; 315/294; 315/297

(57) ABSTRACT

A lighting system for sports equipment is disclosed that includes one or more color-emitting light sources, which can be, for example, red-green-blue light-emitting diodes or flexible video displays, and a computer-based controller configured to vary emissions of said light sources. The sports equipment may be a snow board, snow skis, a skate board, water skis, and a wake board.

### CROSS-REFERENCE TO RELATED APPLICATIONS

This application claims priority to U.S. Provisional Application Ser. No. 61/583,631, filed Jan. 6, 2012, and which is incorporated by reference in its entirety.

### BACKGROUND OF THE INVENTION

The instant disclosure relates to the technical field of sporting equipment, and, more particularly, the field of sporting equipment with lighting systems

An example of prior art in the field of lighting systems for sporting apparatuses includes U.S. Pat. No. 6,802,636 which details the use of LED (light-emitting diode) technology or similar lighting elements embedded inside such sporting apparatus as snowboards, snow skis, skateboards, surfboards, and sky surfboards. Another example of prior art in the field of lighting systems for sporting apparatuses includes U.S. Pat. No. 8,083,238, which details embedding LED technology or similar lighting elements embedded inside such sporting apparatus as snowboards, snow skis, skateboards, and surfboards in which the lighting sources emit light from either the top or the bottom surface of the apparatus. In this patent, a microcontroller may also be incorporated to control the lights sequence of lights or brightness of the lights. A wireless remote control may be incorporated to turn the lights on or off. Also in this patent, a computer interface may also be incorporated to allow the user to download user-desired patterns that can later be replayed by pressing a switch.

A example of prior art in the field of controlling the color of light based on acceleration, which is of interest to the present invention, is U.S. Pat. No. 7,855,658, which outlines a method in which the intensity of red is controlled by one axis of acceleration (eg: x-axis), the intensity of green is controlled by another axis of acceleration (eg: y-axis), and the intensity of blue is controlled by yet another axis of acceleration (eg: z-axis).

Where prior art falls short is offering the ability to change any desired color or pattern of colors on the apparatus. Prior art outlines the use of monochromatic light emitting devices such as LED technology. This limits the potential to control various brightness levels within the designed light-emitting frequency of the illuminating device. Prior art also fails to control the light-emitting devices based on user position, acceleration or rotation. Prior art also fails to consider the ability to wirelessly synchronize the lighting behavior between nearby apparatus. Where prior art in the field of controlling the color of light based on acceleration falls short is due to the nature of how the various sporting apparatus outlined in this patent move. Using three axes of acceleration to control the color of the sporting apparatus drastically limits the variation in color dynamics. The sporting apparatuses mentioned herein spend most of their time with the bottom of the apparatus parallel to the surface of the earth causing most of the acceleration to be exerted on two of the three axes, which results in very little color variation during its use.

### SUMMARY OF THE INVENTION

The detailed description herein is directed to an intelligent lighting system for such sporting apparatus as snowboards, snow skis, skateboards, surfboards, and sky surfboards. One exemplary embodiment of the intelligent lighting system includes one or more light-emitting devices mounted to the sporting apparatus; a power supply; microcontroller; and switching devices (such as field-effect transistors, bipolar junction transistors, relays, etc) for controlling the state or brightness of the light-emitting devices. By altering the red, green, and blue brightness levels, RGB (red-blue-green) light-emitting devices may be utilized to afford reproduction of any color in the visible electromagnetic spectrum.

### BRIEF DESCRIPTION OF THE DRAWINGS

The inventive lighting system is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of a first exemplary embodiment of the lighting system of the present invention;

FIG. 2 is an illustration of the various types of sporting apparatuses on which the exemplary lighting system may be employed;

FIG. 3 illustrates one possible arrangement of an exemplary lighting system attached to a snowboard where the lighting system incorporates strips of RGB LEDs;

FIG. 4 depicts another exemplary embodiment of the present lighting system installed on a snowboard where the lighting system incorporates flexible organic light-emitting diode (OLED) video display material;

FIG. 5 is a functional block diagram of an exemplary lighting system where the lighting system incorporates RGB LEDs;

FIG. 6 is a functional block diagram for another embodiment of the lighting system where the lighting system incorporates an accelerometer, gyro, and GPS unit for controlling individually addressable RGB LEDs;

FIG. 7 is a functional block diagram for yet another embodiment of the lighting system where the lighting system incorporates an accelerometer, gyro, and GPS unit for controlling graphics and video on flexible OLED video displays.

FIG. 8 is a functional schematic of a computer-based processor; and

FIGS. 9A & 9B depict exemplary grid arrays for light sources.

### DETAILED DESCRIPTION

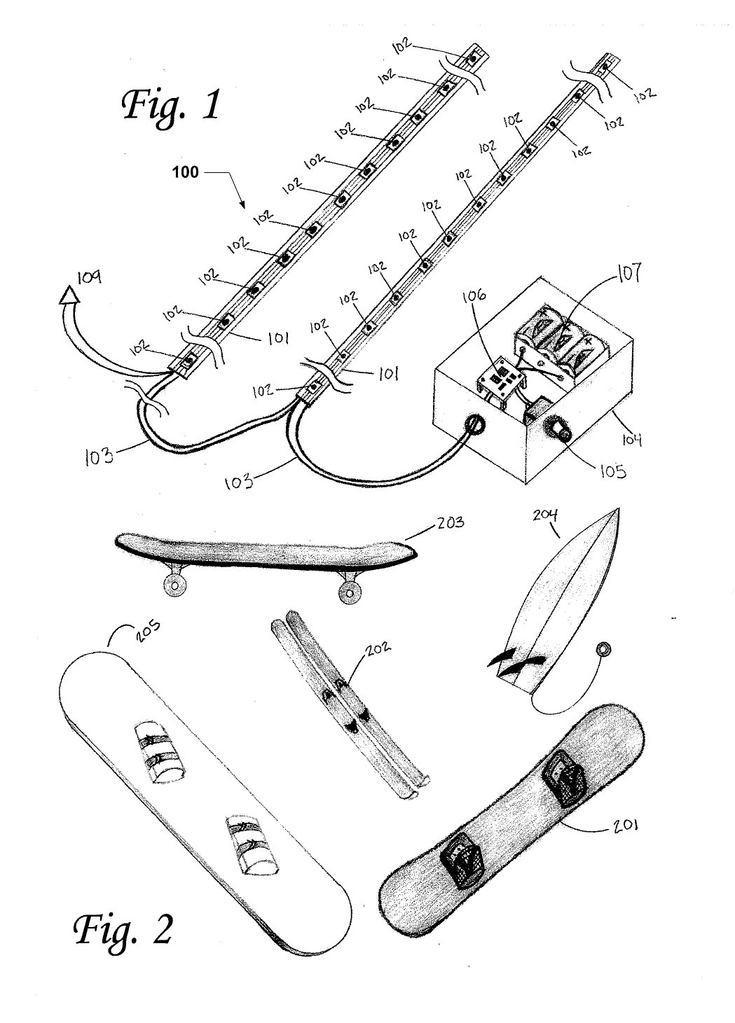

The various embodiments of the present invention and their advantages are best understood by referring to FIGS. 1 through 9B of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

This invention may be provided in other specific forms and embodiments without departing from the essential characteristics as described hereinbelow. The embodiments described are to be considered in all aspects as illustrative only and not restrictive in any manner. The appended claims rather than the following description indicate the scope of the invention.

RGB light-emitting devices are unique from typical light-emitting devices because they contain a composite of three separate red, green and blue light emitting devices encased inside the same body and are designed such that the peak of each color's frequency is ideal for additive reproduction of all visible light frequencies within the electromagnetic spectrum. Additional devices such as MEMS (miniature electro-mechanical sensors) accelerometers, magnetometers, compass modules, gyros, strain gauges, or GPS (global positioning system) receivers may be incorporated. These additional devices may be used to track the position, acceleration, or rotation of the apparatus in order to change the color of the light-emitting devices, generate sequences of multiple colors across multiple light emitting-devices, or to offer gesture recognition and allow the user to define colors, sequences of colors, graphics, or video to display across the light-emitting devices upon a recognized movement or gesture. Another configuration for the intelligent lighting system utilizes the MEMS sensors to generate cues for training purposes. In such a configuration, the system can assist in teaching an individual how to perform specific movements associated with the sport. Wireless networking may be incorporated to allow other intelligent lighting systems on nearby sporting apparatus to synchronize together so that the colors, sequences, patterns, or video may be spanned across multiple apparatus. The sensors and lights may also be used in a configuration to help teach users how to properly operate the apparatus by giving visual and possibly audio cues. For example, strain gauges and accelerometers may be used to help teach an individual how to snowboard by warning the user with a visual lighting cue when they are leaning their weight incorrectly.

One exemplary embodiment utilizes additive primary color RGB (red- blue-green) light-emitting devices that are able to reproduce any color in the visible magnetic spectrum by varying the individual brightness levels of red, green and blue. Although not as common, RYB (red-yellow-blue) light-emitting devices may also be used to reproduce any color in the visible magnetic spectrum in a similar fashion.

Another exemplary embodiment utilizes one or more sensors such as MEMS (miniature electro-mechanical sensors) accelerometers, magnetometers, compass modules, gyros, or GPS (global positioning system) sensors to track the position, rotation or acceleration of the sporting apparatus. The information produced by the sensor or combination of sensors is then used to control the brightness, pattern, sequence, or graphics displayed on the light-emitting devices.

Referring to FIG. 1, this figure illustrates an exemplary lighting system 100 that includes one or more RGB light-emitting devices 102, conductor 103, controller 106, power source 107, and protective housing for the power source and controller 104. The system 100 may also include a switch 105 for selecting the mode and/or controlling the system power. Light-emitting devices 102 may comprise light-emitting diodes (LED), organic light-emitting diodes (OLED), electroluminescent material (EL), or other light-emitting technologies that are capable of generating visible light now known or hereafter developed that suitable for this application as would be appreciated by those skilled in the relevant arts with the benefit of this disclosure. Light-emitting diodes are a preferred solution when multiple sources of light are desired because of their long life, power efficiency, small form factor and durability. For applications where one large surface of uniform light is desired, organic light-emitting diode material could be more suitable. Organic light-emitting diode technology is an evolving technology that is currently available in both a substrate (material backed) and liquid “ink” which can be printed on the surface where the desired light is to be emitted. For applications where video graphics are desired, organic light-emitting diode video display material is available on a flexible substrate.

FIG. 1 illustrates two separate linear strips 101 containing periodic light- emitting devices 102. This configuration may be desired for sporting apparatuses where one strip 101 can be mounted near the edges of the sporting apparatus. For some sporting apparatuses, it may be more desirable to have a single linear strip 101 or additional strips 109. For other sporting apparatuses, it may be more desirable to have a mesh grid (FIGS. 9A & 9B) of light-emitting devices (not shown). In this mesh configuration, the light-emitting devices 102 may be periodically spaced on two separate axes to cover the top surface of the sporting apparatus. In some embodiments, it may be desired for the light-emitting devices to be installed beneath the surfaces of the sporting apparatus such as when manufactured integrally as part of the sporting apparatus. In other embodiments, it may be desired for the light-emitting devices to be surface-mounted in a flexible water-resistant encasement such as when sold as an after-market retrofit kit that the user can install on the sporting apparatus of their choice.

The controller 106 is a printed circuit board that hosts a processor, described in greater detail below, and which may be achieved with a microcontroller, a power supply circuit, coupled to a power source 107, light-emitting devices 102, and control switch 105. In some embodiments, the controller's printed circuit board may also host sensors such as MEMS (miniature electro-mechanical sensors) accelerometers, magnetometers, compass modules, gyros, strain gauges, or GPS (global positioning system) sensors. The power source 107 is a battery and may include any suitable battery, e.g., non-rechargeable alkaline batteries, lead-acid batteries, or similar battery sources. The power source 107 may also include rechargeable lithium-ion polymer, nickel-metal hydride and the like. Although not shown in FIG. 1, in some embodiments the power source may be moved outside of the protective housing for the power source 107 and controller 106 and off the sporting apparatus altogether and onto the user in order to lessen the weight of the sporting apparatus. In this configuration, the power source 107 may enclosed in a belt pack or pack that can strap to the user's arm, waist, or leg and connect to the controller housing with a cable and possibly a quick-disconnect coupling for easy release from the sporting apparatus.

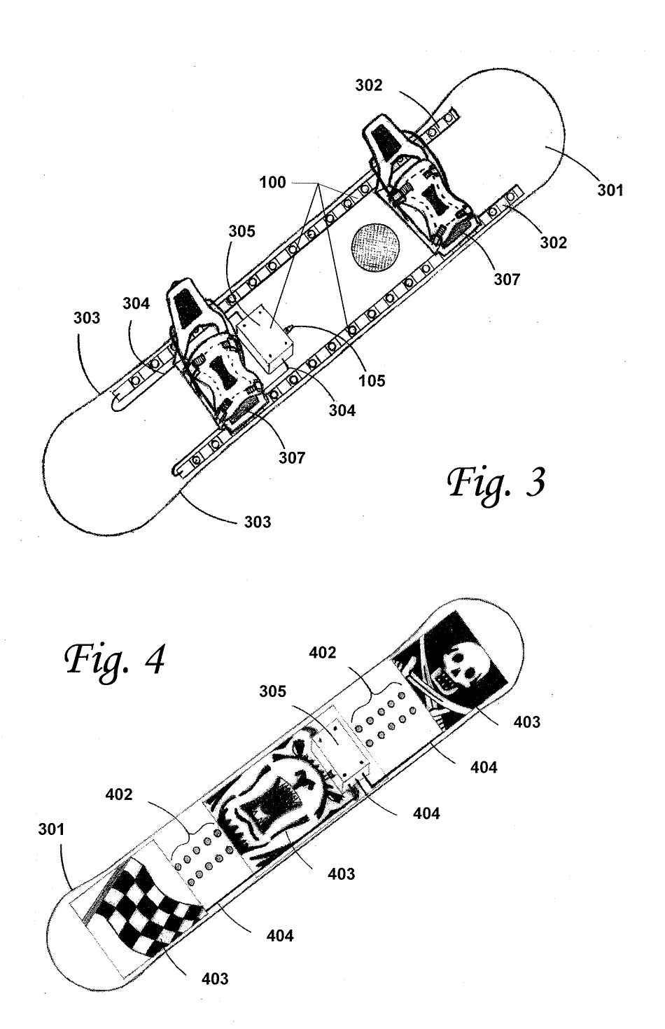

FIG. 2 is an illustration of the various types of sporting apparatuses on which the present invention may be employed. Sporting apparatuses such as snowboards 201, snow skis 202, skateboards 203, surfboards 204, and sky surfboards 205. In subsequent figures (FIG. 3 and FIG. 4) the sporting apparatus is depicted as a snowboard; however, as discussed above, the scope of the present invention encompasses all sporting apparatuses illustrated in FIG. 2. Examples of other platforms on which the inventive lighting system may be installed and used include, without limitation, water skis, and “knee boards”, and the like.

Referring to FIG. 3, the lighting system 100 attached to a snowboard 301 where the lighting system 100 incorporates flexible, waterproof strips of red-green-blue (RGB) light-emitting diodes (LEDs) 302. As shown in FIG. 3, the strips of RGB LEDs 302 may be mounted near the edge 303 of the sporting apparatus. The strips of RGB LEDs 302 may be mounted to the top surface of the sporting apparatus 301 by using a waterproof double-sided adhesive tape. Wiring 304 connects the strips of RGB LEDs 302 to protective housing for the power source and controller 305. Wiring 304 may be covered with flexible protective conduit tubing, which may be attached to the sporting apparatus with a waterproof double-sided adhesive tape. The protective housing for the power source and controller 305 may be mounted to the sporting apparatus so that it does not interfere with normal operation. An example would be mounting it next to one of the bindings 307. The protective housing 305 for the power source and controller may be mounted to the sporting apparatus using a waterproof double-sided adhesive tape, industrial hook-and-loop fasteners, gasket seals, or similar mounting method that prevents moisture from entering the housing interior. A control switch 105 may be mounted on the protective housing 305 for the power source and controller and may be positioned so that the user can operate with a push of a finger or a tap of a foot. Although not shown in FIG. 3, the strips of red-green-blue (RGB) light-emitting diodes (LEDs) 302, wiring 304, or protective housing 305 for the power source 107 and controller 106 may be integrally part of the sporting apparatus.

FIG. 4, depicts another embodiment of the lighting system 100 installed on a snowboard 301 where the lighting system incorporates flexible, waterproof organic light-emitting diode (OLED) video display material 403. The OLED video display material 403 may be mounted to the top surface of the sporting apparatus 401 by using a waterproof double-sided adhesive tape. It will be appreciated that the OLED video display material 403 may be installed beneath the surfaces of the sporting apparatus 401 as well as attached to the surfaces of the apparatus. The OLED video display material 403 may be mounted to the sporting apparatus 401 in a fashion that does not cover the area where the bindings mount to the sporting apparatus 402. Wiring 404 connects the OLED video display material 403 to the protective housing 305 for the power source 107 and controller 106. Wiring 404 may be covered with flexible protective conduit tubing, which may be attached to the sporting apparatus with a waterproof double-sided adhesive tape. The protective housing 305 for the power source 107 and controller 106 may be mounted to the sporting apparatus 301 so that it is not in the way for normal operation. An example would be mounting it next to where one of the bindings mounts to on the sporting apparatus 402. The protective housing 305 for the power source 107 and controller 106 may be mounted to the sporting apparatus using a waterproof double-sided adhesive tape, industrial hook-and-loop fasteners, or similar mounting method. A switch 105 may be mounted on the protective housing for the power source 107 and controller 106 and may be positioned so that the user can operate with a push of a finger or a tap of a foot. The wiring 404, or protective housing 305 for the power source 107 and controller 106 may be installed beneath the outer surfaces of the sporting apparatus.

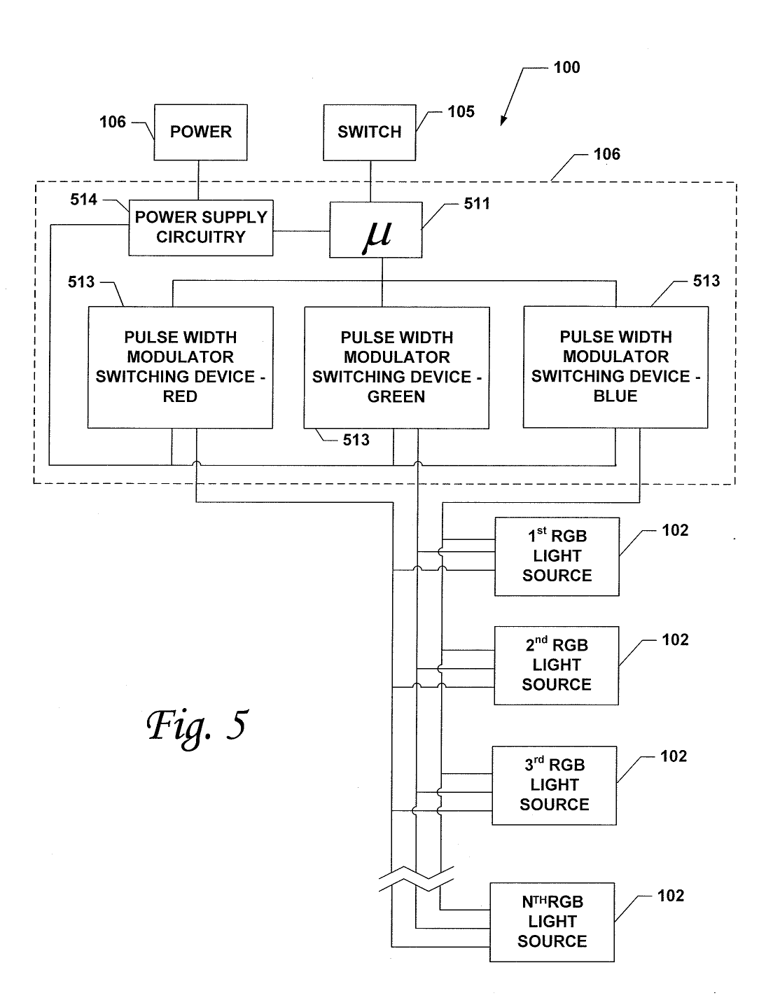

A functional schematic of an exemplary lighting system 100, shown in FIG. 5, may incorporate a plurality of RGB light-emitting diodes (LED) as its RGB light-emitting devices 102. Due to the electrical current-driven nature of LEDs, a pulse-width modulation (PWM) approach of dimming is typically used as opposed to varying the voltages. In the case of PWM dimming control, referring to FIG. 5, a microcontroller 511 interfaces with three separate pulse-width modulation switching devices 513. In this configuration, the microcontroller 511 may use a clock to produce a PWM square-wave signal at a desired fixed frequency and alter its duty cycle in order to change the apparent brightness of the color that is associated with the particular signal. The microcontroller 511 produces three PWM signals, one for each of the primary additive colors: red, green and blue. Because of the insufficient current sourcing or sinking available on today's microcontrollers, external pulse-width modulation switching devices 513 are preferred to handle the load of the RGB light-emitting diodes 102. The three pulse-width modulation switching devices 513 connect to the power supply circuit 514 and drive one or more RGB LEDs 102. These pulse-width modulation switching devices 513 may be achieved with field-effect transistors (FETs), bipolar junction transistors (BJTs), or similar technology. By adjusting the brightness of the three primary additive colors of the RGB LEDs, reproduction of any color in the visible electromagnetic spectrum is possible. The power supply circuit 514 sources its power from a power source 107 and supplies power to the microcontroller 511, pulse-width modulation switching devices 513, and any additional devices such as accelerometers, gyros, GPS receivers, etc. A switch 105 may be provided for user interface, e.g., on/off control, and may also provide mode selection for multiple lighting programs. The microcontroller 511 may be programmed to control the color of the RGB LEDs 102 such that the color is progressed in some order through the entire or partial visible electromagnetic spectrum to display a rainbow of colors at a desired rate. The microcontroller 511 may also be programmed to control the color of the RGB LEDs 102 such that the color is a steady color chosen by the user. The microcontroller 511 may also be programmed to control the color of the RGB LEDs 102 such that the color is flashed in a strobing fashion using a single color or sequence of colors. A computer interface may also be provided to allow the user to program custom-defined colors or color sequences.

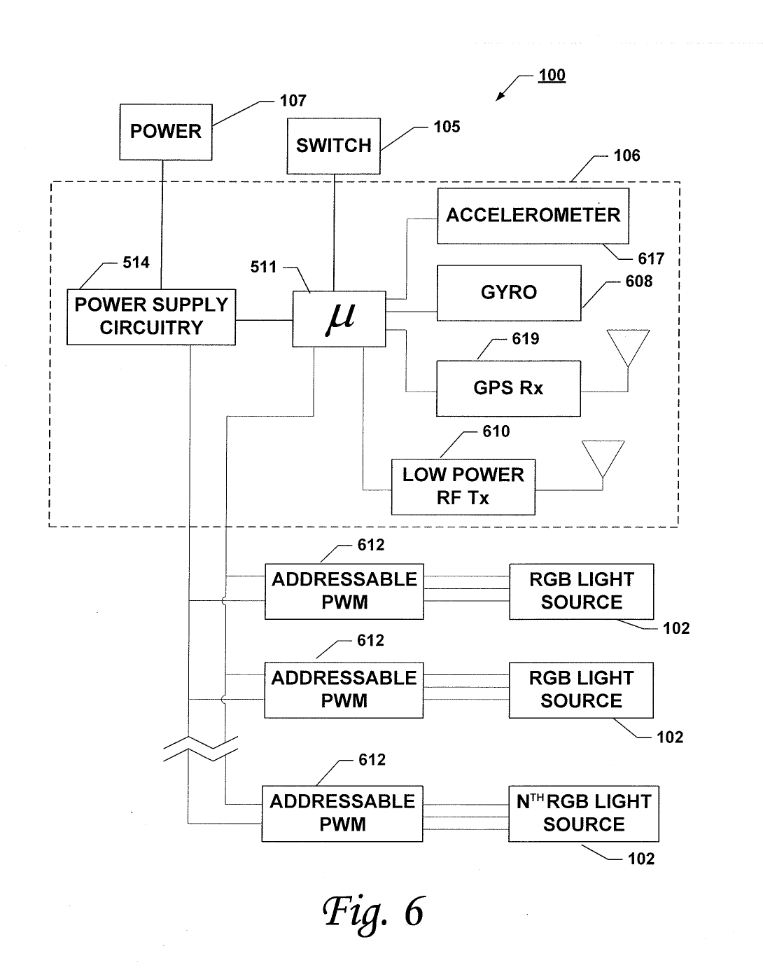

A more elaborate embodiment of the lighting system of the present invention may incorporate a plurality of individually controllable RGB light-emitting diodes (LED) as its RGB light-emitting devices 102. Incorporating individually controllable RGB light-emitting devices affords multiple colors to be displayed simultaneously on any of the RGB light-emitting devices. In this fashion, static or moving colors, words and graphics are possible. In this embodiment, referring to FIG. 6, a microcontroller 511 interfaces with addressable pulse-width modulation (PWM) devices 612. In this configuration, the microcontroller may individually control each of the addressable PWM devices, each of which produces a square-wave signal at a fixed frequency and alters its duty cycle in order to change the apparent brightness of each of the three primary additive colors: red, green and blue of the connected RGB (red-green-blue) light-emitting diode 102. By adjusting the brightness of the three primary additive colors of each the RGB LEDs 102, reproduction of any color in the visible electromagnetic spectrum is possible independently on each of the RGB LEDs 102. The power supply circuit 614 sources its power from a power source 107 and supplies power to the microcontroller 511, addressable PWM devices 612, and any additional devices such as accelerometers 617, gyros 608, GPS receivers 619, etc. A switch 105 may be provided for on/off control and may also provide mode selection for multiple lighting programs. A low-power radio transceiver 610 may be incorporated to allow wireless communication between remote controls or other nearby sporting apparatus to allow synchronization of lighting colors, sequences or graphics.

The microcontroller 511 may be programmed to control the color of each of the RGB LEDs 102 such that the color is progressed in some order through part of or the entire visible electromagnetic spectrum to display a rainbow of colors across the array of RGB LEDs 102 at a desired rate. The microcontroller 511 may also be programmed to control the color of each of the RGB LEDs 102 such that the color is a steady color chosen by the user. The microcontroller 511 may also be programmed to control the color of each of the RGB LEDs 102 such that the color is flashed in a strobing fashion using a single color or sequence of colors. The microcontroller 511 may be programmed to control the color of each of the RGB LEDs 102 such that periodic readings from two axes of an accelerometer 607, a single axis of rotation of a gyro 608, or a compass angle from a GPS receiver 609 are used in an algorithm that calculates and displays an associated color for the angle. This algorithm may create a timeline across the array of RGB LEDs 102 to display a history of a portion of the last color values. The algorithm may be programmed to sequence the timeline in a first-in first-out (FIFO) fashion at a desired rate. The algorithm may also use the accelerator's readings to move the timeline across the array of RGB LEDs 102 in the direction that the sporting apparatus is currently moving. The microcontroller 511 may be programmed to control the color of each of the RGB LEDs 102 such that readings from one axis of an accelerometer 607 or movement on one axis detected by a GPS receiver 609 are used in an algorithm that generates a graphic along the array of LEDs 612 that resembles a comet with a tapering tail. The head of the comet graphic would be the brightest part of the graphic and its orientation would be in the direction in which the sporting apparatus is currently moving and the tail would taper off in the direction opposite of the sporting apparatus' movement. The algorithm may also change the color of the comet tail based on readings from one or more axes of an accelerometer 607 or movement on one or more axes detected by a GPS receiver 609. Further, the control logic may be configured to change the color or intensity of the light sources based upon equipment attitude, geoposition, velocity or acceleration.

A computer interface may be provided to allow the user to program custom-defined colors, color sequences, patterns of colors, or graphics. A computer interface may also be provided to allow the user to program new color changing and graphics algorithms that may become available in the future. The computer interface may include RS-232 serial, universal serial bus (USB), IEEE 802.15.1 (Bluetooth) wireless, or similar computer interface technology.

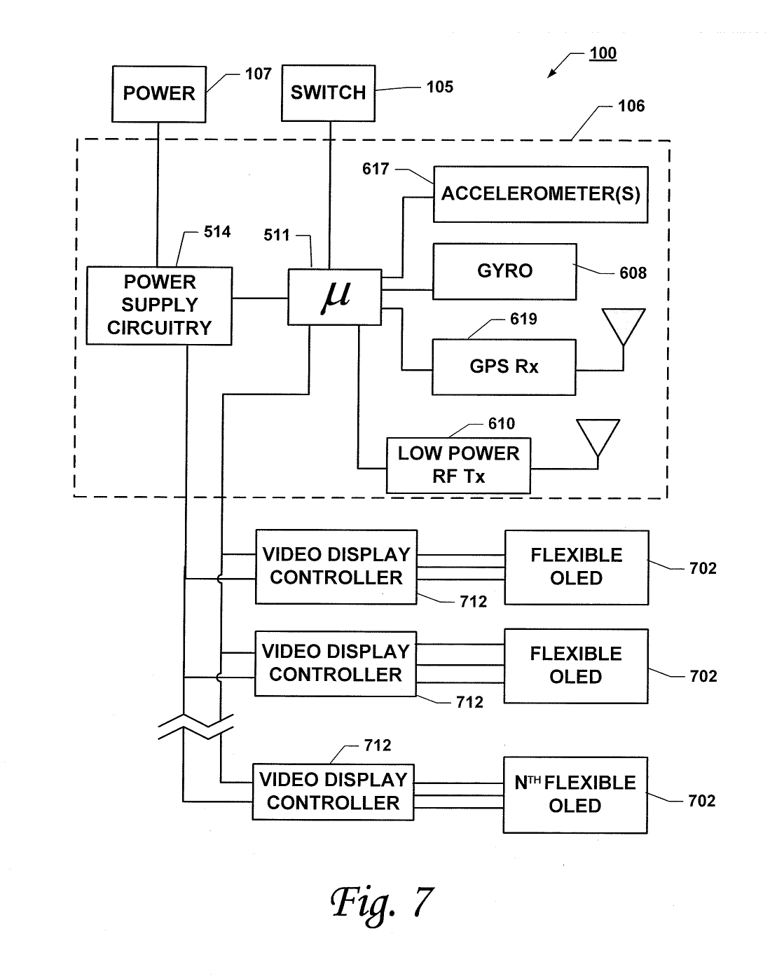

An even more elaborate embodiment of the lighting system may incorporate one or more flexible organic light-emitting diode (OLED) video displays 702 as its light-emitting devices. Incorporating flexible OLED video displays 702 affords static or full-motion video graphics to be displayed on the sporting apparatus, allowing the user to change the look of the apparatus. In this embodiment, referring to FIG. 7, a microcontroller 511 interfaces with one or more video display controllers 712 that drive OLED video displays 702. It will be appreciated that a single video display controller 712 may be used to control multiple OLED video displays 702 if desired. The power supply circuit 514 sources its power from a power source 107 and supplies power to the microcontroller 511, video display controller(s) 712, and any additional devices such as accelerometers 617, gyros 608, GPS receivers 619, etc. A switch 105 may be provided for on/off control and may also provide mode selection of multiple video graphics programs. A low power radio transceiver 610 may be incorporated to allow wireless communication between remote controls or other nearby sporting apparatus to allow synchronization of lighting colors, sequences or graphics. A computer interface may be provided to allow the user to program custom-defined colors, color sequences, patterns of colors, graphics, or video. A computer interface may also be provided to allow the user to program new color changing and graphics algorithms that may become available in the future. The computer interface may include RS-232 serial, universal serial bus (USB), IEEE 802.15.1 (Bluetooth) wireless, or similar computer interface technology.

The controller 106 and the microcontroller 511, as will be appreciated by those skilled in the arts, may be one or more computer-based processors. Such a processor may be implemented by a field programmable gated array (FPGA), application specific integrated chip (ASIC), programmable circuit board (PCB), or other suitable integrated chip (IC) device.

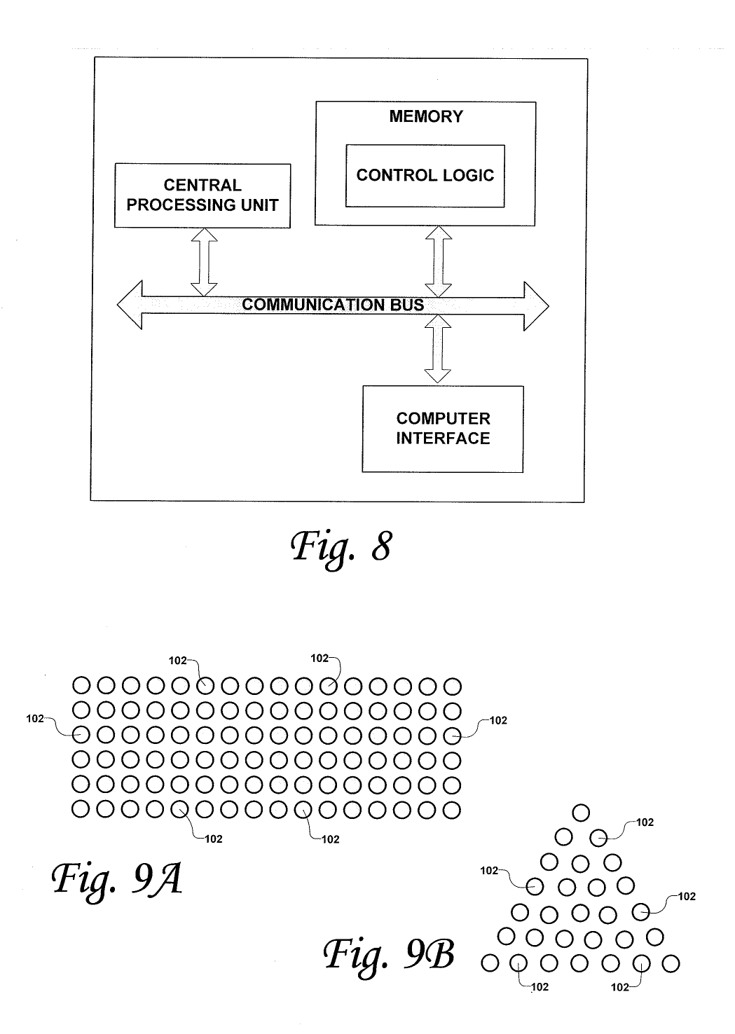

With reference to FIG. 8, a processor in effect comprises a computer system. Such a computer system includes, for example, one or more central processing units (CPUs) that are connected to a communication bus. The computer system can also include a main memory, such as, without limitation, flash memory, read-only memory (ROM), or random access memory (RAM), and can also include a secondary memory. The secondary memory can include, for example, a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a computer usable storage medium having stored therein computer software and/or data.

The secondary memory can include other similar means for allowing computer programs or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

Computer programs (also called control logic) are stored in the main memory and/or secondary memory. Computer programs can also be received via the communications interface. Such computer programs, when executed, enable the computer system to perform certain features of the present invention as discussed herein. In particular, the computer programs, when executed, enable a control processor to perform and/or cause the performance of features of the present invention. Accordingly, such computer programs represent controllers of the computer system.

A processor, and the processor memory, may advantageously contain control logic or other substrate configuration representing data and instructions, which cause the processor to operate in a specific and predefined manner as, described hereinabove. The control logic may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic may be installed on the memory using a computer interface couple to the communication bus which may be any suitable input/output device. The computer interface may also be configured to allow a user to vary the control logic, either according to pre-configured variations or customizably.

The control logic conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as ASICs, FPGAs, PCBs, microcontrollers, or multi-chip modules (MCMs). Implementation of the hardware state machine so as to perform the functions described herein will be apparent to persons skilled in the relevant art(s).

In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In another embodiment, features of the lighting system are implemented primarily in hardware using, for example, hardware components such as ASICs, FPGAs, PCBs, microcontrollers, or a multi-chip module (MCM). Implementation of the hardware state machine so as to perform the functions described herein will be apparent to persons skilled in the relevant art(s). In yet another embodiment, features of the invention can be implemented using a combination of both hardware and software.

As described above and shown in the associated drawings, the present specification describes an intelligent lighting system for sporting apparatus. While particular embodiments of the system have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A sports apparatus having a lighting system comprising:
one or more light sources;
a power source; and
a control processor configured with a computer-readable memory having control logic for varying output of each light source of said one or more light sources.

2. The sports apparatus of claim 1, wherein said sports apparatus is one of a snow board, a skate board, a surf board, a wake board, snow skis, and water skis.

3. The sports apparatus of claim 2, wherein said output is color.

4. The sports apparatus of claim 3, further comprising one or more accelerometers and wherein said control processor is responsive to acceleration signals output by said one or more accelerometers and is configured with control logic for varying output of each light source of said one or more light sources based upon said acceleration signals.

5. The sports apparatus of claim 3, wherein said one or more light sources comprises a plurality of red-green-blue light-emitting diodes.

6. The sports apparatus of claim 5, wherein said plurality of red-green-blue light-emitting diodes is disposed in an array, said array being one of a linear array, and a two-dimensional array.

7. The sports apparatus of claim 5, comprising one or more pulse width modulators for varying pulse width signals received by each said light source of said one or more light sources, said pulse width signals corresponding to pulse widths of at least one of red light wavelengths, green light wavelengths, and blue light wavelengths in response to control output signals from said control processor.

8. The sports apparatus of claim 7, further comprising one or more accelerometers and wherein said control processor is responsive to acceleration signals output by said one or more accelerometers and is configured with control logic for varying the output of each light source of said plurality of light sources based upon said acceleration signals.

9. The sports apparatus of claim 3, wherein said one or more light sources comprises one or more flexible organic light-emitting diode video displays and further comprising one or more video display controllers for controlling the display of said one or more flexible organic light-emitting diode video displays said one or more video display controllers responsive to said control processor.

10. The sports apparatus of claim 9, further comprising one or more accelerometers and wherein said control processor is responsive to acceleration signals output by said one or more accelerometers and is configured with control logic for varying the output of each light source of said plurality of light sources based upon said acceleration signals.

11. A lighting system installable on sports equipment comprising:
one or more color-emitting light sources;
a computer-based controller configured to vary emissions of said light sources; and
wherein said sports equipment consists of one of a snow board, snow skis, a skate board, water skis, and a wake board.

12. The lighting system of claim 11, wherein said computer-based controller is configured to vary emissions of said light sources based upon a pre- determined algorithm.

13. The lighting system of claim 11, further comprising a radio frequency transceiver coupled to said computer-based controller; and wherein said computer-based controller is configured to vary emissions of said light sources based upon input received via said radio frequency transceiver.

14. The lighting system of claim 11, wherein said computer-based controller is configured to vary the brightness of at least one of red light, green light and blue light, in response to changes in at least one of sports equipment attitude, position, velocity and acceleration.

15. The lighting system of claim 14, wherein said one or more light sources comprises a plurality of red-green-blue light-emitting diodes.

16. The lighting system of claim 15, wherein said plurality of red-green-blue light-emitting diodes comprises an array, said array being one of a linear array and a two-dimensional array.

17. The lighting system of claim 11, wherein said one or more light sources comprises one or more flexible organic light-emitting diode video displays and further comprising one or more video display controllers for controlling the display of said one or more flexible organic light-emitting diode video displays said one or more video display controllers responsive to said computer-based controller.

18. The lighting system of claim 17, wherein said computer-based controller is configured to vary the display of said one or more flexible organic light-emitting diode video displays according to a pre-determined algorithm.

19. The lighting system of claim 11, wherein said system is installed beneath one or more surfaces of said sporting equipment.

20. The lighting system of claim 19, further comprising a radio frequency transceiver coupled to said computer-based controller; and wherein said computer-based controller is configured to vary emissions of said light sources based upon input received via said radio frequency transceiver.

21. The lighting system of claim 19, wherein said computer-based controller is configured to vary the brightness of at least one of red light, green light and blue light, in response to changes in at least one of sports equipment attitude, position, velocity and acceleration.

22. The lighting system of claim 21, wherein said one or more light sources comprises a plurality of red-green-blue light-emitting diodes.

23. The lighting system of claim 22, wherein said one or more light sources comprises one or more flexible organic light-emitting diode video displays and further comprising one or more video display controllers for controlling the display of said one or more flexible organic light-emitting diode video displays said one or more video display controllers responsive to said computer-based controller.
